(19) United States
(12) Patent Application Publication
(10) Pub. No.: US 2018/0308020 A1
(43) Pub. Date: Oct. 25, 2018

(54) SYSTEMS AND METHOD FOR GENERATING A PROXY-SCORING MODEL

(71) Applicant: Sandeep DAS, Kolkata (IN)

(72) Inventor: Sandeep DAS, Kolkata (IN)

(21) Appl. No.: 15/495,851

(22) Filed: Apr. 24, 2017

(51) Int. Cl. G06Q 10/06; G06N 5/02

(52) U.S. Cl. CPC G06Q 10/067; G06N 5/022

(57) ABSTRACT

A method and system for generating a proxy-scoring model for a business model in case of temporary data non-availability post implementation of the business model, could be anticipated. The present disclosure provides an alternative approach for calculating a proxy score of a business model, using a multi-data scoring model, such that said alternative approach is not only easy to implement but is also time and cost efficient and successfully provides a real time solution in case of data non-availability post implementation.

### FIELD OF THE DISCLOSURE

The present disclosure generally relates to the field of business analysis and prediction models and is more specifically directed to systems and methods for generating a proxy-scoring model in case of data non-availability post implementation of a business model.

### BACKGROUND OF RELATED ART

Businesses across the world today use predictive models for improving their business decisions and creating larger impact on their customers. A predictive model is capable of predicting the chance of occurring of an arbitrary phenomenon or act of its occurrence. Specifically, scoring models are those predictive models that assign points based on known information or data and predicts an unknown outcome. A common example of a scoring model is the credit scoring model that predicts the probability of a user defaulting on a loan.

In order to build any predictive or scoring model, data corresponding to one or more variables coming from one or more data sources is required. In some cases, post implementation of a model, data corresponding to one or more variables are not available, which initiates the need of re-building the model by considering the available data or by using an alternate data point that characterizes the missing data point. However, this approach is cost-ineffective, time consuming and requires substantial amount of additional effort. Since rebuilding a model is often time consuming, the absence of any data, post implementation of a model results in non-availability of the model projection till the model is re-built.

A similar challenge is faced in cases of poor data quality, information technology challenges and budget constraints. For instance, a population shift in any of the key driver variables in the data that is used to build a predictive model, necessitates re-building of the entire model. Similarly, IT challenges such as unstandardized update processes may corrupt/harm the data which results into unavailability of such data and therefore, the model may be required to be rebuilt. Also, sometimes the data used for building a predictive model may be purchased from a third party and it may be difficult to timely refresh or re-purchase such data. This also results in the need to re-build the data model.

For reasons mentioned above, there emerged a need for building a process using which a proxy score can be generated that is at least comparable to the score of the actual model. One of the ways in which proxy score is calculated is by using proxy variables, wherein proxy variables of the missing variables are found out from the development sample or by using multi-bureau data. Thereafter, such proxy variables are used to re-calculate the score. However, this requires substantial amount of time to change the implementation of the existing model and therefore, hampers the uninterrupted use and/or availability of the model to predict outcomes.

Another approach towards calculating a proxy score is by re-assigning weights of the variables and using zero weightage for the variables that are unavailable. Although this approach is not substantially time-consuming, re-assigning the weights of other variables may not produce outcomes comparable to the original model. Yet another approach existing in the art to solve the above-mentioned problem of re-building the model, is to revamp or refurbish the entire model with most recent data that is available. However, this approach has a number of drawbacks such as time and cost ineffectiveness and non-availability of the model or a prompt/real-time solution till the time new score is not available.

Another existing approach involves individual level scoring and then triangulating individual level score to overall level. However, it is extremely difficult to define best possible triangulation weights to roll up scores from different levels to a single level. Further, if one data source is unavailable then re-calculating the triangulation weights may be difficult and if re-calculated, such weights may not be very efficient.

In light of the above, there exists a need for developing a system and method for calculating a proxy score of a model in case of data non-availability post implementation, wherein such systems and methods provide a real-time solution and ensures un-interrupted decision making using said models.

The approaches described above are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

This section is provided to introduce certain objects and aspects of the disclosed methods and systems in a simplified form that are further described below in the detailed description. This summary is not intended to identify the key features or the scope of the claimed subject matter.

In view of the shortcomings of existing approaches for generating a proxy score, there exists a need for developing a more efficient, cost-effective and easy to use system and method for calculating a proxy score of a model in case of data non-availability post implementation that not only overcomes or at least substantially reduces the problems of the prior art, but also provides a real-time solution. It is therefore an object of the present disclosure to provide systems and methods for calculating a proxy score of a model in case of data non-availability post implementation that ensures un-interrupted access of the business model.

In view this and other objects, one aspect of the present disclosure relates to a method to generate a proxy score/projection of a business model based on a plurality of statistically significant variables, the method comprising: receiving a first set of standard model projection generated based on a first data set of said statistically significant variables, wherein said first set of standard model projection is generated during a model development phase. This is followed by generating a second set of standard model projection based on a second data set of said statistically significant variables, wherein said second set of standard model projection is generated during a post-implementation phase and wherein said second data set of statistically significant variables is an incomplete set.

Subsequently, said plurality of statistically significant variables are categorized into a plurality of groups based on a data source of said independent variables, wherein said plurality of groups during model development phase comprises at least one complete group and at least one incomplete group such that data set of said at least one incomplete group is incomplete/missing post the business model implementation. Next, a base model for each of said plurality of groups is generated based at least on said first data set and second data set, to generate a base model projection set. Based on a data set for said at least one complete group, a multi-data model is generated to further generate a multi-data model projection set, wherein generating multi data model includes at least one new statistically significant variable not yet utilized in base model to generate said multi-data model projection set to enhance projection power for incomplete group. Lastly, the process involves generating a proxy scoring model based on said base model and said multi-data model, to generate a proxy score model projection set, wherein said proxy score model projection set is based on said base model projection set and said multi-data model projection set.

Another aspect of the present invention relates to a system for generating a proxy score/projection of a business model based on a plurality of statistically significant variables, comprising a memory comprising one or more program instruction modules and a processor operable to execute said one or more program instruction modules. The program instruction modules comprises a standard model generator module for generating a first set of standard model projection based on a first data set of said statistically significant variables, wherein said first set of standard model projection is generated during a model development phase. The standard model generator module is further configured to generate a second set of standard model projection based on a second data set of said statistically significant variables, wherein said second set of standard model projection is generated during a post-implementation phase and wherein said second data set of statistically significant variables is an incomplete set.

The program instruction modules also comprise a base model generator module for categorizing said plurality of statistically significant variables into a plurality of groups based on a data source of said independent variables, wherein said plurality of groups comprises at least one complete group and at least one incomplete group such that data set of said at least one incomplete group is incomplete/missing post the business model implementation, and wherein said base model generator is further configured to generate a base model for each of said plurality of groups based at least on said first data set and second data set, to generate a base model projection set.

Further, the program instruction modules also include a multi-data model generator module for generating a multi-data model based on a data set for said at least one complete group, to generate a multi-data model projection set, wherein generating multi data model includes at least one new statistically significant variable not yet utilized in base model to generate said multi-data model projection set to enhance projection power for incomplete group; and a proxy score model generator module for generating a proxy scoring model based on said base model and said multi-data model, to generate a proxy score model projection set, wherein said proxy score model projection set is based on said base model projection set and said multi-data model projection set.

Yet another aspect of the invention relates to a non-transitory computer-readable storage medium storing one or more sequences of instructions, the instructions, when executed by one or more processors, cause the one or more processors to perform steps comprising receiving a first set of standard model projection generated based on a first data set of said statistically significant variables, wherein said first set of standard model projection is generated during a model development phase. Subsequently, a second set of standard model projection is generated based on a second data set of said statistically significant variables, wherein said second set of standard model projection is generated during a post-implementation phase and wherein said second data set of statistically significant variables is an incomplete set.

Next, said plurality of independent variables are categorized into a plurality of groups based on a data source of said independent variables, wherein said plurality of groups comprises at least one complete group and at least one incomplete group such that data set of said at least one incomplete group is incomplete/missing post the business model implementation. This is followed by generating a base model for each of said plurality of groups based on at least on said first data set and second data set, to generate a base model projection set; generating a multi-data model based on a data set for said at least one complete group, to generate a multi-data model projection set, wherein generating multi data model includes at least one new statistically significant variable not yet utilized in base model to generate said multi-data model projection set to enhance projection power for incomplete group; and generating a proxy scoring model based on said base model and said multi-data model, to generate a proxy score model projection set, wherein said proxy score model projection set is based on said base model projection set and said multi-data model projection set.

The foregoing shall be more apparent in the following detailed description of the invention.

### BRIEF DESCRIPTION OF THE DRAWINGS

The accompanying drawings, which are incorporated herein, and constitute a part of this disclosure, illustrate exemplary embodiments of the disclosed methods and systems in which like reference numerals refer to the same parts throughout the different drawings. Some drawings may indicate the components using block diagrams and may not represent the internal circuitry of each component. It will be appreciated by those skilled in the art that disclosure of such drawings include disclosure of electrical components or circuitry commonly used to implement such components.

FIG. 1 illustrates an example computer environment suitable for implementing the system and method for generating a proxy-scoring model, in accordance with exemplary embodiments of the present disclosure.

FIG. 2 illustrates in block diagram for the system for generating a proxy-scoring model, in accordance with exemplary embodiments of the present disclosure.

FIG. 3 illustrates the method to generate a proxy-scoring model, in accordance with exemplary embodiments of the present disclosure.

### DETAILED DESCRIPTION OF EXEMPLARY EMBODIMENTS

The following description of example methods and systems is not intended to limit the scope of the description to the precise form or forms detailed herein. Instead in the following description, for the purposes of explanation, various specific details are set forth in order to provide a thorough understanding of the disclosed embodiments. It will be apparent, however, that the disclosed embodiments may be practiced without these specific details.

Several features described hereafter can each be used independently of one another or with any combination of other features. However, any individual feature may not address any of the problems discussed above or might address only some of the problems discussed above. Some of the problems discussed above might not be fully addressed by any of the features described herein. Although headings are provided, information related to a particular heading, but not found in the section having that heading, may also be found elsewhere in the specification.

### GENERAL OVERVIEW

The present disclosure relates to methods and systems for generating a proxy scoring model for any business model when there is a need to re-build the model post-implementation due to data non-availability. As used herein, a “predictive model”, “business model” and “predictive business model” refer to any statistical predictive model that is capable of predicting an outcome based on one or more variables of data. The phrases “predictive model”, “business model” and “predictive business model” have been used interchangeably throughout this specification. The invention encompasses a business model comprising a number of independent variables that are processed/manipulated to observe its effect on a dependent variable or outcome variable.

The business model referred to herein and the standard model, base model and multi-data model generated by the systems and methods of this disclosure, may be a binary logistic model or any other additive multiple linear regression model. Further, the business model may be a credit scoring model, an acquisition model, a behaviour model, a collection scorecard model, a fraud scorecard model, a response model, etc.

Said business model is implemented or built using/based on a set of data of variables or parameters that may be statistically significant to build the model. For the purposes of this specification, this time frame when a business model is implemented using one or more data points is known as a “model development phase”.

As used herein, “statistically significant variable” refers to one or more variables that if and when used to implement a business model, are likely to significantly impact the outcome predicted by the model, wherein said impact is caused by something more than random chance. Statistically significant variables may be defined as per information contained and degree of interdependence to explain the relationship between dependent and independent variables. This is measured by P-Value after performing standard pre-model development univariate, bivariate and multivariate diagnostic checks like Trend checking, Binning & Classing, Variance Influence Factor, Information Value etc. These statistically different variables belong to/come from one or more data sources. For instance, in case of a credit scoring model, the data sources may include, but are not limited to, internal performance data, demographic data, external data, etc.

During model development phase, a first set of standard model projection is generated based on a first data set of statistically significant variables. For the purposes of this specification, “projection set” refers to the set of predicted values of a dependent variable or the outcome variable, wherein said prediction is based on the entire set of independent variables. Post-implementation of the business model, data corresponding to one or more variables from one or more data sources may become unavailable due to one or more reasons as discussed in the background section. As used herein, “post-implementation” refers to a time frame any time after the implementation of a business model. In an embodiment, post implementation refers to a time frame immediately after the implementation of a business model. In another embodiment, post implementation refers to a time frame when data corresponding to one or more variables become unavailable after the implementation of the business model.

Post implementation, a second set of standard model projection is generated based on a second set of statistically significant variables, wherein said second set is an incomplete set. As used herein, “an incomplete set” refers to data set corresponding to one or more variables wherein data corresponding to at least one variable is missing or unavailable. In an embodiment, the first set of statistically significant variables and the second set of statistically significant variables may be the same, the only difference being that the second set is an incomplete set.

Next, the one or more statistically significant variables are categorized into one or more groups based on the data source from which said variables emerge, wherein at least one of the groups is an incomplete group. The incomplete group refers to a group comprising one or more variables such that data corresponding to at least one of these variables is missing or unavailable. For each of the groups generated (whether complete or incomplete), a base model or sub-model is generated using data from the first data set and the second data set, belonging to said group, wherein the base model generates a base model projection set. The base model projection set is generated based on all informative variables from first data set and second data set. In case of response models suitable calibration methods are used to transform probabilistic output to additive scores for ease of use and comparability.

Subsequently, during the model development phase itself, a multi-data model is generated for one or more of the complete groups and excluding those groups that are anticipated to be missing post-implementation, to generate a multi-data model projection set. Generating multi data model includes at least one new statistically significant variable not yet utilized in base model to generate said multi-data model projection set to enhance projection power for incomplete group. In an embodiment, calibration is performed to obtain additive scores. Based on the base model projection set and the multi-data model projection set, a proxy scoring model is generated to produce a proxy a scoring model projection set.

The proxy scoring model encompassed by this disclosure is an alternative approach to develop a data model in case of data non-availability post implementation, and helps in real-time decision making by providing alternative proxy score which can perform close enough to the original model.

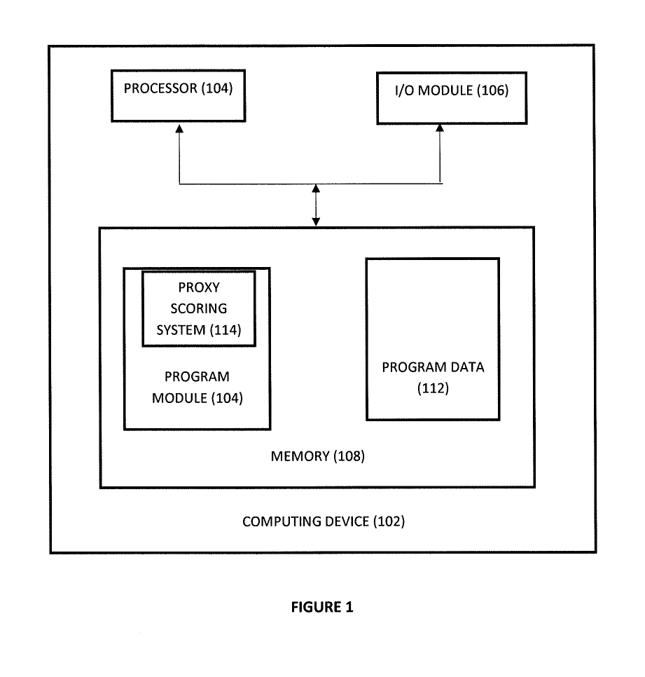

FIG. 1 illustrates an example computer environment suitable for implementing the system and method for generating a proxy-scoring model, in accordance with exemplary embodiments of the present disclosure. As shown in FIG. 1, systems and methods for generating a proxy-scoring model encompassed by the present disclosure may be implemented on a computing device 102 comprising a processor 104, an input/output module 106 and a memory 108. The memory 108 further comprises at least one program module 110 and at least one program data 112, wherein the program module 110 comprises one or more modules/systems or components, including a system for generating a proxy-scoring model.

The computing device 102 may be any electronic device including, but not limited to, a mobile phone, smart phone, pager, laptop, a general purpose computer, desktop, personal digital assistant, tablet computer, mainframe computer, or any other computing device as may be obvious to a person skilled in the art. In an embodiment, the computing device 102 is a specialized computing device configured to perform statistical analysis. In another embodiment, the computer device 102 represents several different interconnected computers or computer systems operating as a cloud-based computing system.

The processor 104 is coupled to the I/O module 106 and the memory 108, wherein the processor 104 is configured to fetch instructions stored in the memory 108 and execute such instructions. The computing device 102 including the memory and the processor are described in detail in the Hardware Overview section of this specification.

The disclosure also encompasses implementing the system and method for generating a proxy-scoring model as an application with a graphical user interface, executing on one or more computing devices. In an embodiment, the system and method for generating a proxy-scoring model may be implemented as a mobile application.

The performance or accuracy of the proxy scoring model may be determined by using one or more evaluation metrics such as Kolmogorov Smirnov chart, Gini coefficient, confusion matrix, Concordant-Discordant ratio, Root mean squared error, AUC-ROC, etc. The evaluation metric used depends upon the type of predictive model for which a proxy-scoring model is being generated.

### System Overview

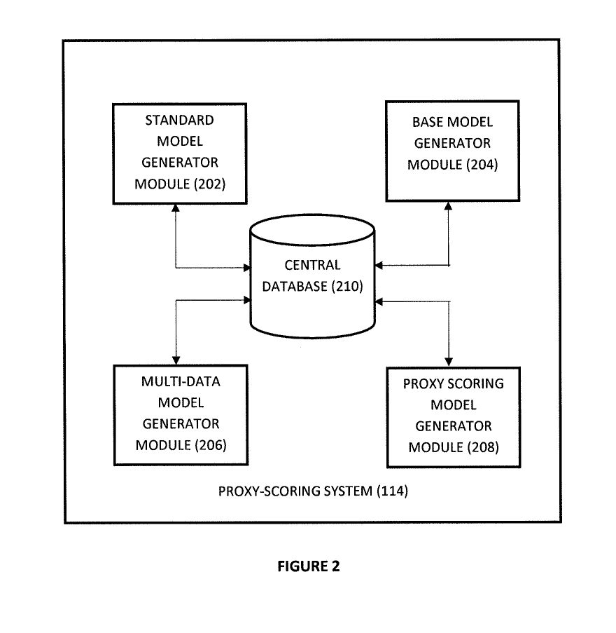

FIG. 2 illustrates in block diagram for the system for generating a proxy-scoring model, in accordance with exemplary embodiments of the present disclosure.

The system for generating a proxy-scoring model 114 comprises at least a standard model generator module 202, a base model generator module 204, a multi-data model generator module 206 and a proxy model generator module 208, all connected to a central database 210.

The standard model generator module 202 is configured to receive a first data set of at least a plurality of statistically significant variables from the central database 210 and generate a standard model based on said first data set. The standard model generator 202 is further configured to generate a first set of standard model projection based on the first data set. The first data set comprises of one or more values of data for each of said statistically significant variables, during the model development phase. In an embodiment, the standard model generator module receives directly the first set of standard model projection from the central database 210, wherein this set may be provided by the user via the I/O interface 106 of the computing device 102.

The standard model generator module 202 is further configured to receive a second data set of said statistically significant variables based on which the module generates a second set of standard model projection. The second data set comprises of one or more values of data for each of said statistically significant variables, during post implementation phase, such that second data set is an incomplete set.

The standard model generator module 202 is configured to store this first set and second of standard model projection in the central database 210 for storage. In an embodiment, standard model generator module 202 is configured to send a request to retrieve the first data set and the second data set from the user, wherein said request is sent to the user by the I/O module 106.

The base model generator module 204 is configured to retrieve the statistically significant variables used by the standard model generator module 202, and categorize said variables into a plurality of groups, wherein such grouping is done on the basis data source of said statistically significant variables. In an embodiment, the categorization of statistically significant variables is based on type information contained by variables and/or source of origin. At least one of the groups generated by the base generator module is an incomplete group such that its data set is incomplete or missing post implementation. The disclosure encompasses an incomplete group wherein the data corresponding to all the statistically significant variables in the group are missing or unavailable. The disclosure also encompasses an incomplete group wherein the data corresponding to only one or more statistically significant variables in the group are missing or unavailable.

The base model generator module 204 is further configured to generate a base model for each of said groups based on the first data set and the second data set, wherein the base model generates a base model projection set. These base models for each of said groups may also be referred to as sub-models. This base model projection set along with the groups are sent by the base model generator module 204 to the central database 210 for storage. In an embodiment, the base model is generated based on the first data set and a reject inference set, wherein said reject inference set refers to a data set for which the projection set was negative. The concept of reject inference particularly relates to acquisition scorecard models, wherein the entire ‘Through The Door’ (TTD) population is required to be screened by the developed model whereas while developing model only ‘Known Good Bad’ (KGB) performance is available based on only approved population. Thus reject inference technique is used to simulate impact for ‘Unknown Good Bad’ population to calculate final impact on total TTD population.

The multi-data model generator 206 is configured to retrieve data set for the one or more complete groups formed by the base model generator 204, and generate a multi-data model based on this data set. The multi-data model generates a multi-data projection set by using independent sub models on groups and then rolling up the sub models to calculate final impact by using one or more forms of triangulation methods. Generating multi data model includes at least one new statistically significant variable not yet utilized in base model to generate said multi-data model projection set to enhance projection power for incomplete group. In one embodiment, the data set for complete groups is retrieved from the base model generator 204, while in another embodiment, data set for complete groups is retrieved from the central database 210.

The disclosure encompasses a multi-data model generated by the multi-data model generator 206 that is based on not only the data set for the complete groups (that comprises data for statistically significant variables already used by the standard model and the base model), but is also based on at least one new statistically significant variable not yet utilized in the base model to enhance the projection power for the incomplete group.

The proxy scoring model generator 208 is configured generate a proxy scoring model based on said base model and said multi-data model. The proxy scoring model generator 208 retrieves the base model projection set and the multi-data model projection set based on which the module generates a proxy scoring model projection set.

Central database 210 is configured to store the first data set and the second data set. The database 210 is also configured to store the first set of standard projection model and second set of standard projection. Further, the database 210 also stores the base model projection set, multi-data model projection set and the proxy scoring model projection set. In an embodiment, the central database is located in the proxy scoring system 114, whereas in another embodiment, the central database is located in the program data module 112 of the memory 108.

The central database 110 is also configured to store the statistically significant variables and information relating to which variable comes from which data source. The database 210 also stores any information, data, result, intermediate processing results, etc. received by and/or generated by any of the modules/components of the proxy scoring system. Although only one central database is shown in FIG. 2, the disclosure encompasses one or more databases or storage units for storing the data/information received at and generated by, the system.

Though the system for generating a proxy-scoring model as illustrated in FIG. 2 shows different modules for performing different tasks, it will be appreciated by persons skilled in the art, that the present disclosure is not limited to the modules shown in the FIG. 2, and one or more modules may be used to perform the task, steps, methods, functions as discussed above.

### Process Overview

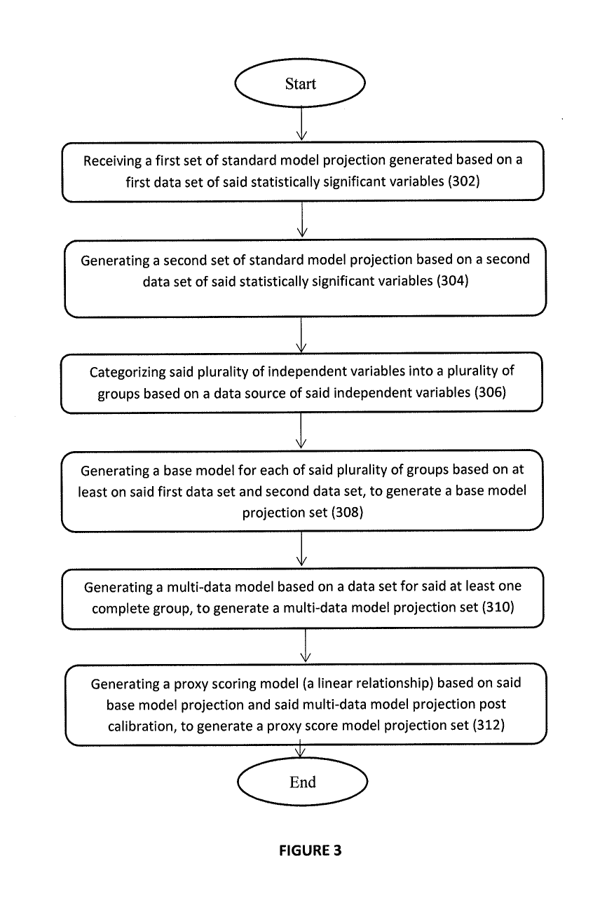

FIG. 3 illustrates the method to generate a proxy-scoring model, in accordance with exemplary embodiments of the present disclosure. The disclosure encompasses performing pre-modeling data cleaning, variable transformation and variable selection, before beginning the method 300. In an embodiment, the method 300 may be initiated only after a request for creation of proxy scoring model is received from the user at the proxy scoring system via the I/O module of the computing device. The method begins at step 302, wherein a first set of standard model projection is received, where this first set of standard model projection is generated based on a first data set of statistically significant variables during the model development phase.

Subsequently, at step 304, a second set of standard model projection based on a second data set of statistically significant variables, is generated, wherein second data set is an incomplete set. This second set of standard model projection is calculated post-implementation of the business model.

Next, at step 306, the statistically significant variables are categorized into a plurality of groups based on the data source of said variables. In an embodiment, grouping may be done on the basis of type of source or type of information used. The plurality of groups comprises at least one complete group and at least one incomplete group, wherein said incomplete group is incomplete/missing post-implementation.

At step 308, a base model or sub-model for each of said plurality of groups is generated based on said first data set and second data set to further generate a base model projection set. In an embodiment, the base model projection set is generated based on the first data set and a reject inference set. Subsequently, at step 310, a multi-data model is generated for at least one complete group to generate multi data projection set, wherein generating multi data model includes at least one new statistically significant variable not yet utilized in base model to generate said multi-data model projection set to enhance projection power for incomplete group. In an embodiment, the multi data projection model is generated at the time of model development if it can be anticipated during model development that which of the variables/data sources become missing post implementation. In such an embodiment, new statistically significant variables that have not been used in the base model, are used to boost up the power of the multi-data model.

At step 312 a proxy scoring model is generated based on the base model and the multi-data model to generate a proxy score model projection set, wherein said proxy score model projection set is generated based on establishing linear relationship between said base model projection set and said multi-data model projection set post calibration.

In an embodiment, every time the method 300 is performed, the standard model, base model, multi-data model and proxy model generated by the method are timestamped and/or assigned a unique identification.

Although the process of generating a proxy-scoring model is described above in a sequence of steps, the present disclosure encompasses such steps to be performed in any order. Further, one or more non-essential steps may be missed or not implemented while generation of a proxy-scoring model.

The present disclosure also encompasses a non-transitory computer-readable storage medium storing one or more sequences of instructions, the instructions, when executed by one or more processors, cause the one or more processors to perform the following steps: receiving a first set of standard model projection generated based on a first data set of said statistically significant variables, wherein said first set of standard model projection is generated during a model development phase. This is followed by generating a second set of standard model projection based on a second data set of said statistically significant variables, wherein said second set of standard model projection is generated during a post-implementation phase and wherein said second data set of statistically significant variables is an incomplete set.

Next, said plurality of independent variables are categorized into a plurality of groups based on a data source of said independent variables, wherein said plurality of groups comprises at least one complete group and at least one incomplete group such that data set of said at least one incomplete group is incomplete/missing post the business model implementation. Next, a base model for each of said plurality of groups is generated based on at least on said first data set and second data set, to generate a base model projection set; followed by generating a multi-data model based on a data set for said at least one complete group, to generate a multi-data model projection set. Lastly, a proxy scoring model is generated based on said base model and said multi-data model, to generate a proxy score model projection set, wherein said proxy score model projection set is based on said base model projection set and said multi-data model projection set.

### Hardware Overview

According to one embodiment of the present disclosure, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

The computing device may include a bus or other communication mechanism for communicating information, and a processor coupled with the bus for processing information. The hardware processor may be, for example, a general purpose microprocessor.

The computing device may also include a main memory, such as a random access memory (RAM) or other dynamic storage device, coupled to the bus for storing information and instructions to be executed by the processor. The main memory also may be used for storing temporary variables or other intermediate information during execution of instructions to be executed by the processor. Such instructions, when stored in non-transitory storage media accessible to the processor, render the computer system into a special-purpose machine that is customized to perform the operations specified in the instructions.

The computing device further includes a read only memory (ROM) or other static storage device coupled to the bus for storing static information and instructions for the processor. A storage device, such as a magnetic disk, optical disk, or solid-state drive is provided and coupled to the bus for storing information and instructions.

The computing device may be coupled via the bus to a display, such as a cathode ray tube (CRT), for displaying information to a computer user. An input device, including alphanumeric and other keys, is coupled to the bus for communicating information and command selections to the processor. A cursor control, such as a mouse, a trackball, or cursor direction keys, may also be coupled to the bus for communicating direction information and command selections to the processor and for controlling cursor movement on the display. The cursor control typically has two degrees of freedom in two axes, a first axis (e.g., x) and a second axis (e.g., y), that allows the cursor control to specify positions in a plane.

The computing device may implement the techniques described herein using customized hard-wired logic, one or more ASICs or FPGAs, firmware and/or program logic which causes the computer system to be a special-purpose machine. According to one embodiment, the techniques herein are performed by the computing device in response to the processor executing one or more sequences of one or more instructions contained in the main memory. Such instructions may be read into the main memory from another storage medium, such as the storage device. Execution of the sequences of instructions contained in the main memory cause the processor to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as the storage device. Volatile media may include dynamic memory, such as the main memory. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, or any other memory chip or cartridge.

Storage media is distinct from, but may be used in conjunction with, transmission media. Transmission media participates in transferring information between storage media. For example, transmission media may include coaxial cables, copper wire and fiber optics, including the wires that comprise the bus. Transmission media can also take the form of acoustic or light waves, such as those generated during radio-wave and infra-red data communications.

Various forms of media may be involved in carrying one or more sequences of one or more instructions to the processor for execution. For example, the instructions may initially be carried on a magnetic disk or solid-state drive of a remote computer. The remote computer can load the instructions into its dynamic memory and send the instructions over a telephone line using a modem.

The computing device also includes a communication interface coupled to the bus. The communication interface provides a two-way data communication coupling to a network link that is connected to a local network. For example, the communication interface may be an integrated services digital network (ISDN) card, cable modem, satellite modem, or a modem to provide a data communication connection to a corresponding type of telephone line. As another example, the communication interface may be a local area network (LAN) card to provide a data communication connection to a compatible LAN. Wireless links may also be implemented. In any such implementation, the communication interface sends and receives electrical, electromagnetic or optical signals that carry digital data streams representing various types of information.

The network link typically provides data communication through one or more networks to other data devices. For example, the network link may provide a connection through the local network to a host computer or to data equipment operated by an Internet Service Provider (ISP). The ISP in turn provides data communication services through the world wide packet data communication network now commonly referred to as the “Internet”. The local network and the Internet both use electrical, electromagnetic or optical signals that carry digital data streams. The signals through the various networks and the signals on the network link and through the communication interface, which carry the digital data to and from the computing device, are example forms of transmission media.

The computing device can send messages and receive data, including program code, through the network(s), the network link and the communication interface. In the Internet example, a server might transmit a requested code for an application program through the Internet, the ISP, the local network and the communication interface. The received code may be executed by the processor as it is received, and/or stored in the storage device, or other non-volatile storage for later execution.

As may be apparent from the above description of disclosed methods and systems for generating a proxy-scoring model, this approach provides an alternate solution to derive a comparable score in case of non-availability of data post implementation. One advantage of the systems and methods of the present disclosure is that more number of statistically significant variables may be utilized at the sub-model level in comparison with the conventional approach. Another advantage is that generating proxy model is a one-time job and is easy to implement. Yet another advantage lies in the fact that data preparation does not require any additional time.

It will be appreciated by those skilled in the art that proxy scoring model described herein above is a not a complete replacement of having original data and performing statistical analysis on such data, however, the proxy-scoring model helps in real-time decision making by providing alternative comparable score. Further, during proxy score development ‘next best’ significant variables which were not yet used in base model can be utilized at sub model level to compensate for likely influence of anticipated missing information on model predictability power.

In one embodiment, the proxy-scoring model may be used by any financial services company or any other organization that specializes in credit scoring.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

We claim:

1. A computer-implemented method to generate a proxy score/projection of a business model based on a plurality of statistically significant variables, the method comprising:
receiving a first set of standard model projection generated based on a first data set of said statistically significant variables, wherein said first set of standard model projection is generated during a model development phase;
generating a second set of standard model projection based on a second data set of said statistically significant variables, wherein said second set of standard model projection is generated during a post-implementation phase and wherein said second data set of statistically significant variables is an incomplete set;
categorizing said plurality of independent variables into a plurality of groups based on a data source of said independent variables,
wherein said plurality of groups comprises at least one complete group and at least one incomplete group such that data set of said at least one incomplete group is incomplete/missing post the business model implementation;
generating a base model for each of said plurality of groups based on at least on said first data set and second data set, to generate a base model projection set;
generating a multi-data model based on a data set for said at least one complete group, to generate a multi-data model projection set,
wherein generating multi data model includes at least one new statistically significant variable not yet utilized in base model to generate said multi-data model projection set to enhance projection power due to incomplete group; and
generating a proxy scoring model based on said base model and said multi-data model, to generate a proxy score model projection set,
wherein said proxy score model projection set is based on said base model projection set and said multi-data model projection set.

2. The computer-implemented method of claim 1 wherein generating a base model for each of said plurality of groups may be based on said first data set and a reject inference set.

3. The computer-implemented method of claim 1 wherein said standard model, said base model and said multi-data model may be a binary logistic model or any other additive multiple linear regression model.

4. The computer-implemented method of claim 1 further comprising maintaining a central database, wherein said central database stores one or more of said standard model projection set, said base model projection set, said multi-data model projection set and said proxy score model projection set.

5. A system for generating a proxy score/projection of a business model based on a plurality of statistically significant variables, the system comprising:
a memory comprising one or more program instruction modules, the one or more program instruction modules comprising
a standard model generator module for generating a first set of standard model projection based on a first data set of said statistically significant variables, wherein said first set of standard model projection is generated during a model development phase, and
wherein said standard model generator module is further configured to generate a second set of standard model projection based on a second data set of said statistically significant variables, wherein said second set of standard model projection is generated during a post-implementation phase and wherein said second data set of statistically significant variables is an incomplete set;
a base model generator module for categorizing said plurality of statistically significant variables into a plurality of groups based on a data source of said independent variables,
wherein said plurality of groups comprises at least one complete group and at least one incomplete group such that data set of said at least one incomplete group is incomplete/missing post the business model implementation, and
wherein said base model generator is further configured to generate a base model for each of said plurality of groups based at least on said first data set and second data set, to generate a base model projection set;
a multi-data model generator module for generating a multi-data model based on a data set for said at least one complete group, to generate a multi-data model projection set,
wherein generating multi data model includes at least one new statistically significant variable not yet utilized in base model to generate said multi-data model projection set to enhance projection power for incomplete group;
a proxy score model generator module for generating a proxy scoring model based on said base model and said multi-data model, to generate a proxy score model projection set,
wherein said proxy score model projection set is based on said base model projection set and said multi-data model projection set; and
a processor operable to execute the one or more program instruction modules.

6. The system of claim 5 wherein said base model generator module may be configured to generate a base model for each of said plurality of groups based on said first data set and a reject inference set.

7. The system of claim 5 wherein said standard model, said base model and said multi-data model may be one of a binary logistic model and an additive regression model.

8. The system of claim 5 wherein said business model may be one of a credit scoring model, an acquisition model, a behaviour model, a collection scorecard model, a fraud scorecard model, a response model.

9. The system of claim 5 further comprising a central database for storing one or more of said standard model projection set, said base model projection set, said multi-data model projection set and said proxy score model projection set.

10. A non-transitory computer-readable storage medium storing one or more sequences of instructions, the instructions, when executed by one or more processors, cause the one or more processors to perform steps comprising:
receiving a first set of standard model projection generated based on a first data set of said statistically significant variables, wherein said first set of standard model projection is generated during a model development phase;
generating a second set of standard model projection based on a second data set of said statistically significant variables, wherein said second set of standard model projection is generated during a post-implementation phase and wherein said second data set of statistically significant variables is an incomplete set;
categorizing said plurality of independent variables into a plurality of groups based on a data source of said independent variables,
wherein said plurality of groups comprises at least one complete group and at least one incomplete group such that data set of said at least one incomplete group is incomplete/missing post the business model implementation;
generating a base model for each of said plurality of groups based on at least on said first data set and second data set, to generate a base model projection set;
generating a multi-data model based on a data set for said at least one complete group, to generate a multi-data model projection set,
wherein generating multi data model includes at least one new statistically significant variable not yet utilized in base model to generate said multi-data model projection set to enhance projection power for incomplete group; and
generating a proxy scoring model based on said base model and said multi-data model, to generate a proxy score model projection set,
wherein said proxy score model projection set is based on said base model projection set and said multi-data model projection set.
